(19) United States
(12) Patent Application Publication
(10) Pub. No.: US 2021/0289482 A1
(43) Pub. Date: Sep. 16, 2021

(54) DATA AIDED RECEIVERS FOR ULTRA-RELIABLE LOW LATENCY COMMUNICATIONS

(71) Applicant: QUALCOMM Incorporated, San Diego, CA (US)

(72) Inventors: Amit BAR-OR TILLINGER, Petach Tikva (IL); Gideon Shlomo KUTZ, Ramat Hasharon (IL); Assaf TOUBOUL, Netanya (IL); Shay LANDIS, Hod Hasharon (IL); Michael LEVITSKY, Rehovot (IL); Guy WOLF, Rosh Haayin (IL); Ronen SHAKED, Kfar Saba (IL)

(21) Appl. No.: 16/816,179

(22) Filed: Mar. 11, 2020

(51) Int. Cl. H04W 72/04; H04L 25/02

(52) U.S. Cl. CPC H04W 72/042; H04L 25/0202

(57) ABSTRACT

This disclosure provides systems, devices, apparatus and methods, including computer programs encoded on storage media, for data aided receivers for URLLC. With more specificity, a UE may encode and modulate at least one of control information or data from a first code block received through a first channel from a base station to obtain an encoded and modulated reference first code block. A comparison between the reference first code block and the first code block may be performed by the UE to estimate a second channel for receiving a second code block from the base station. After receiving the second code block from the base station, the UE may demodulate and decode the second code block based on the second channel that was estimated via the comparison of the reference first code block to the first code block.

### BACKGROUND

### Technical Field

The present disclosure relates generally to communication systems, and more particularly, to data aided receivers for ultra-reliable low latency communications (URLLC).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An URLLC may be based on a downlink (DL) reception that is received over a shortened number of symbols in a slot. However, as two DMRSs may be required to perform channel estimation, decoding and processing of code blocks in the DL reception may not begin until after the second DMRS is received. Thus, to provide low latency, all of the decoding and processing may be performed between the symbol in which the second DMRS is received and the last symbol of the slot. A shortened window of time for decoding and processing the code blocks may result in high peak processing demands and over-dimensioning of hardware to satisfy such demands, even though the hardware may be idle up until the second DMRS is received. Furthermore, shortening the DL reception to provide more time for decoding and processing may increase overhead caused by the pilot symbols, as two DMRSs may still be required to perform channel estimation regardless of a shortened DL reception/symbol duration. Large pilot overhead may result in either less data being transmitted or having to transmit the data at a higher coding rate, both of which may have an impact on device performance/coverage.

Accordingly, data aided receivers may be utilized for decoding the code blocks independent of DMRS. An absence of DMRS from an URLLC subframe may be based on re-encoding and re-modulating control information and/or data obtained from a first code block received through a first channel to further obtain a reference first code block. The reference first code block may be compared to the first code block to estimate a second channel for a second code block. The second code block may be decoded based on the estimated second channel. A cycle of using a reference code block as a phase reference for the next symbol may be continued for N code blocks in the DL reception. In this manner, since no symbols need to be allocated for receiving DMRS, not only may decoding of the first code block begin immediately after the first code block is received, but additional code blocks may be received in symbols that may otherwise have been reserved for receiving the DMRS, thereby increasing the coding rate/throughput of the data. Additionally or alternatively, since no symbols need to be allocated for receiving the DMRS, the DL reception time may be shortened by the time needed for symbols that may otherwise have been reserved for receiving the DMRS, which may decrease latency.

In an aspect of the disclosure, a method, a computer-readable medium, and an apparatus are provided. The apparatus may be a wireless device at a UE that includes a memory and at least one processor coupled to the memory. The memory may include instructions that, when executed by the at least one processor, causes the at least one processor to encode and modulating at least one of control information or data from a first code block received through a first channel from a base station to obtain an encoded and modulated reference first code block. The at least one processor may estimate a second channel for a second code block based on a comparison between the reference first code block and the first code block. Accordingly, when the second code block is from the base station, the at least one processor may demodulate and decoding the second code block based on the second channel that is estimated based on the comparison between the reference first code block and the first code block.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a call flow diagram illustrating communications between a UE and a base station

FIG. 5 is a diagram that illustrates an example URLLC subframe having DMRS.

FIG. 6 is a diagram that illustrates an example URLLC subframe for improving a coding rate/throughput.

FIG. 7 is a diagram that illustrates an example URLLC subframe for decreasing latency.

FIG. 8 is a flowchart of a method of wireless communication at a UE.

FIG. 9 is a conceptual data flow diagram illustrating the data flow between different means/components in an example apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

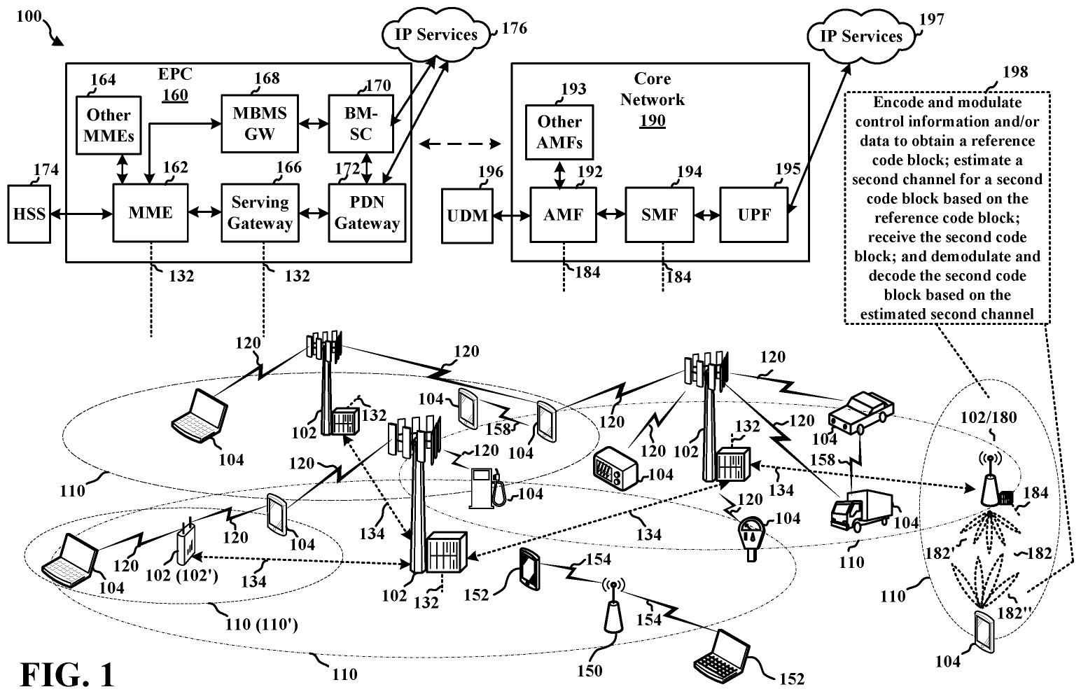

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to encode and modulate control information and/or data to obtain a reference code block; estimate a second channel for a second code block based on the reference code block; receive the second code block; and demodulate and decode the second code block based on the estimated second channel (198). Although the following description may be focused on 5G NR, the concepts described herein may be applicable to other similar areas, such as LTE, LTE-A, CDMA, GSM, and other wireless technologies.

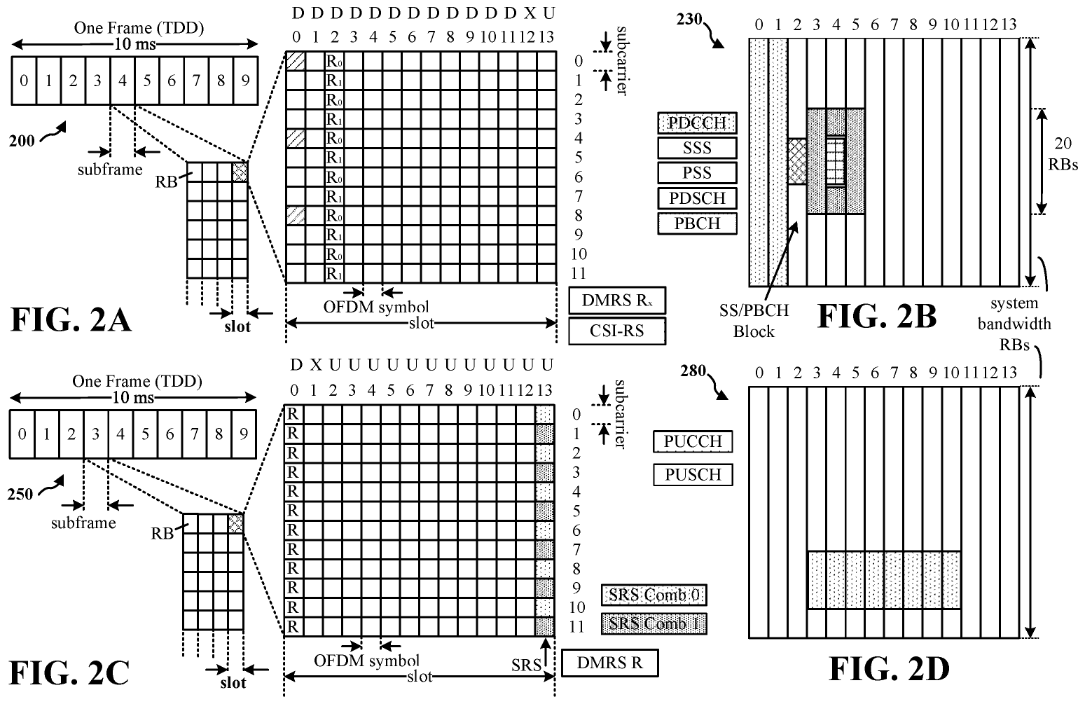

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

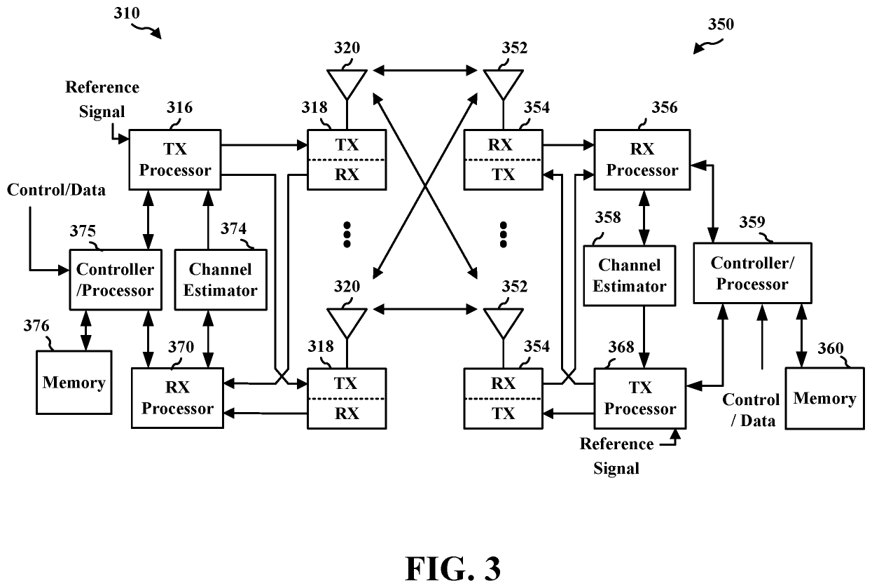

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and URLLC may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

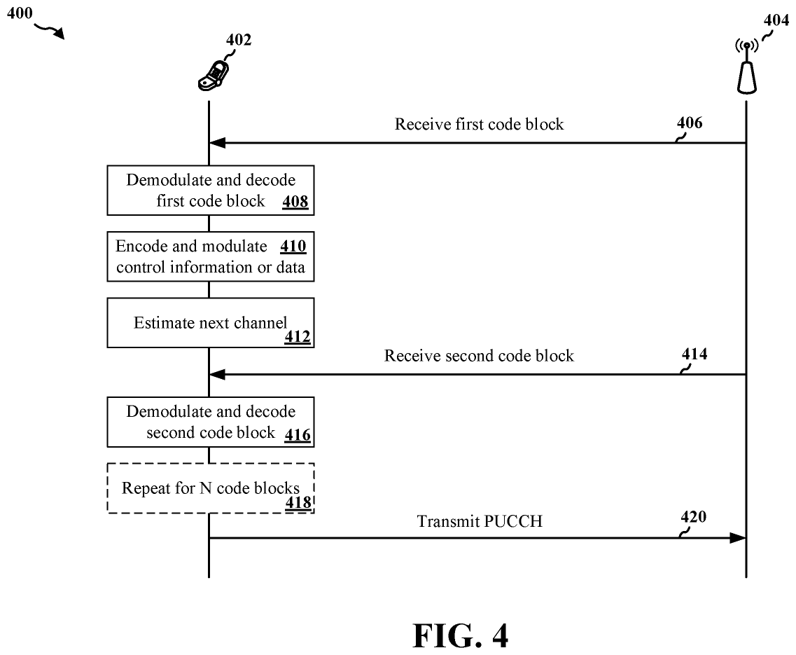

FIG. 4 is a call flow diagram 400 illustrating communications between a UE 402 and a base station 404. At 406, the UE 402 receives a first code block from the base station 404. The first code block may be received through a first channel. At 408, the UE 402 demodulates and decodes the first code block to obtain, for example, control information and/or data from the first code block. At 410, the UE 402 encodes and modulates the control information and/or the data from the first code block to obtain an encoded and modulated reference first code block. For example, the control information and/or the data may be re-encoded and re-modulated by the UE 402. At 412, the UE 402 estimates a next channel (e.g., a second channel) for a second code block based on a comparison between the first code block and the reference first code block.

At 414, the UE 402 receives the second code block from the base station 404. The second code block may be received through the second channel. At 416, the UE 402 demodulates and decodes the second code block based on the second channel (e.g., the next channel that was estimated at 412). The UE 402 may obtain, based on the demodulated and decoded second code block at 416, data from the second code block. At 418, the UE 402 may repeat for the next N code blocks, the process of encoding and modulating data to obtain an encoded and modulated reference code block for estimating each successive channel, so that a next code block received in the next channel may be demodulated and decoded. At 420, the UE 402 transmits a PUCCH to the base station 404. The PUCCH may include an acknowledgement (ACK)/negative acknowledgement (NACK) indicative of whether the UE 402 successfully decoded the code blocks received from the base station 404.

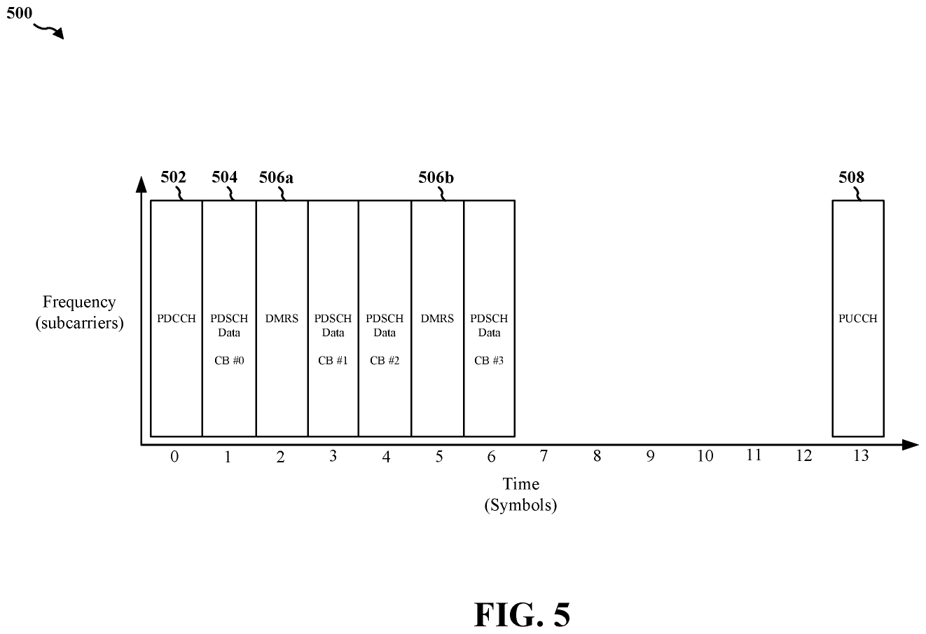

FIG. 5 is a diagram 500 that illustrates an example URLLC subframe having DMRS. An URLLC may be based on a DL reception by a UE over a shortened number of symbols in a slot. For example, to achieve a lower latency in a 14-symbol slot, the DL reception may be received over a lesser number of symbols than that required to fill the 14-symbol slot. In the diagram 500, the DL reception for the URLLC is received in symbol 0 to symbol 6. However, any number of symbols less than that required to fill the slot may correspond to an URLLC. In some configurations, even just 1 symbol of DL information may be sufficient for an URLLC.

In the diagram 500, control information is received in a PDCCH 502 at symbol 0 followed by data received in a PDSCH 504 at symbols 1, 3, 4, and 6. A first DMRS 506a and a second DMRS 506b may also be included in the DL reception, as two DMRSs may be required for channel estimation in some configurations. In aspects, symbols that include DMRS (e.g., the first DMRS 506a and/or the second DMRS 506b) may employ frequency division multiplexing (FDM) to receive both DMRS and data in a same symbol. For example, some REs in the same symbol may be utilized for receiving DMRS and other REs may be utilized for receiving data. Following a series of empty symbols from symbol 7 to symbol 12, an UL transmission may be communicated to a base station in a PUCCH 508 at symbol 13. The PUCCH 508 may provide feedback to the base station indicative of whether the DL reception was successfully decoded or not. For example, the UE may transmit an ACK to the base station via the PUCCH 508 when the UE successfully decodes the DL reception or a NACK to the base station via the PUCCH 508 when the UE does not successfully decode the DL reception.

Symbols 1, 3, 4, and 6 of the diagram 500 each include a corresponding code block, for example, CB #0, CB #1, CB #2, and CB #3, respectively. In some configurations, URLLC receivers may not begin decoding and processing the first code block (e.g., CB #0) until after the second DMRS 506b is received. For example, two DMRSs 506a-506b may be required for estimating the channel in order to begin decoding and processing the code blocks. Thus, to provide low latency via the corresponding PUCCH 508, all the decoding and processing of the code blocks should be performed in a shortened timeframe from symbol 6 to symbol 13 of the diagram 500. As a result, high peak processing demands may occur for decoding and processing the code blocks based on the shortened timeframe, which may further necessitate over-dimensioning hardware capabilities of the UE to provide sufficient processing power to satisfy the demands of peak processing—even though for a portion of the time/symbols such hardware may be idle (e.g., from symbol 0 to symbol 5 in the diagram 500).

Furthermore, overhead caused by pilot symbols (e.g., DMRS symbols) may become much larger as the number of symbols used for the DL reception decreases. That is, two pilot symbols may need to be maintained for tracking the channel so that interpolation may be performed between the two pilot symbols, regardless of a symbol length of the DL reception. In a non-URLLC, two symbols pilot may be used over 14 symbols for a pilot overhead of 1/7. However, because the DL reception for an URLLC is shorter and because two pilot symbols may need to be maintained for estimating the channel, the pilot overhead in the diagram 500, for example, may be almost doubled to ¼ of the utilized symbols. In cases where the DL reception is even shorter than that of the diagram 500, the pilot overhead caused by having two pilot symbols may become very large (e.g., 50 percent or more). As large pilot overhead results in less bandwidth and less REs for transmitting data, either less data may need to be transmitted or the data may need to be transmitted based on a higher coding rate. In either case, large pilot overhead may impact the performance/coverage area of the UE.

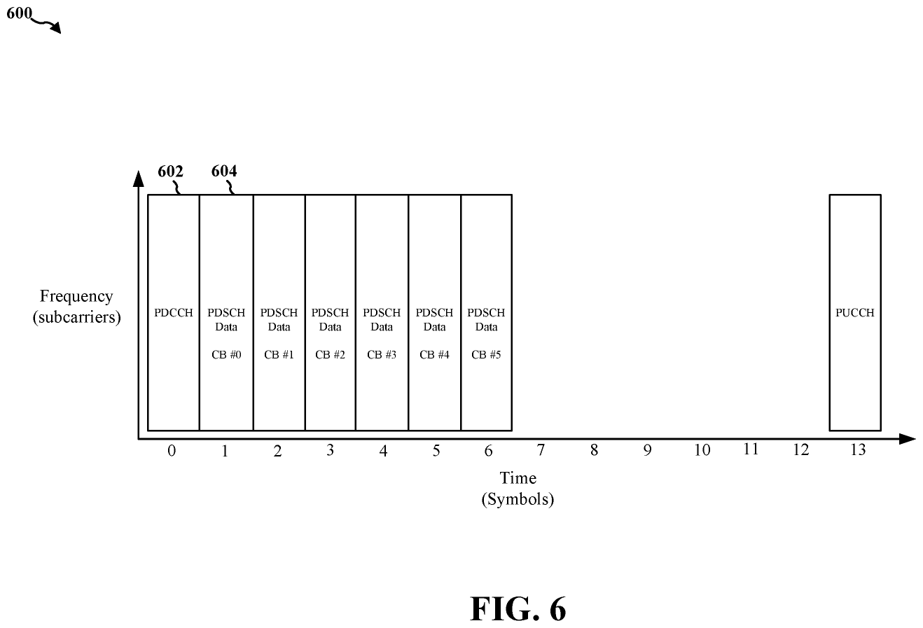

FIG. 6 is a diagram 600 that illustrates an example URLLC subframe for improving a coding rate/throughput of data. Data aided receivers for an URLLC may be utilized to permit removal of DMRS from symbols of the URLLC subframe. For example, a length of the DL reception in the diagram 600 is a same length as the DL reception in the diagram 500. However, the DL reception in the diagram 600 includes additional code blocks in place of the DMRSs 506a-506b that were include in symbols 2 and 5 of the diagram 500. Including the additional code blocks in the DL reception of the same length as the diagram 500 may increase the coding rate/throughput of the data and thereby improve spectral efficiency.

An absence of DMRS from the diagram 600 may be based on a re-encoding scheme for the data aided receivers of the URLLC. In aspects, control information may be received in a PDCCH 602 at symbol 0. The control information may include instructions for decoding code blocks that are received subsequent to the PDCCH 602 (e.g., CB #0, CB #1, CB #2, CB #3, CB #4, and CB #5). Thus, demodulation and decoding of the DL reception may begin with the PDCCH 602 based on a set of pilots included in the PDCCH 602. In some cases, a pilot structure of the PDCCH 602 may be sparse due to a robustness of the PDCCH 602.

A channel estimation for demodulating and decoding a subsequent code block may be obtained based on a number of techniques. For example, after the PDCCH 602 is demodulated and decoded, the PDCCH 602 may then be re-encoded and re-modulated and used as a reference code block/pilot for demodulating and decoding data received in a PDSCH 604 at a next symbol (e.g., symbol 1). Demodulated and decoded data received at symbol 1 may similarly be re-encoded and re-modulated and used as a next reference code block/pilot for demodulating and decoding data at symbol 2. Since pilots may be identified at symbol 1 and symbol 2 based on the re-encoding scheme/reference code blocks, an interpolation may be performed between the pilots to estimate the channel at symbol 3. The process of using re-encoded and re-modulated data from the prior symbol to estimate the channel for the next symbol may likewise continue in this manner for the remainder of the code blocks included in the DL reception.

Accordingly, rather than utilizing extra resources/symbols in the diagram 600 to transmit DMRS, the data that is received via the PDSCH 604 may be re-encoded and re-modulated and used as a pilot in place of DMRS. By reducing pilot overhead caused by including the DMRS in the URLLC subframe, a higher throughput and/or an increased performance/coverage area of the UE may be provided. Specifically, more data may be transmitted for a given range and/or a given signal-to-noise ratio (SNR) in certain instances.

In cases where the PDCCH 602 and the PDSCH 604 are provided via different beamforming techniques, other methods may be desirable for obtaining the channel estimation for the PDSCH 604, as the different beamforming techniques may result in differences among the channels of the PDCCH 602 and the PDSCH 604. Thus, in some configurations, a single DMRS may be included in the DL reception to estimate the channel for the subsequent code block. The one DMRS may occupy a full symbol or part of a symbol in the URLLC subframe. In other configurations, DMRS may have a sparse pilot structure that partially occupies a symbol of the URLLC subframe, where FDM is used based on the sparse pilot structure and robust data. The robust data may then be demodulated/decoded and re-encoded/re-modulated to serve as a dense pilot for estimating the next channel.

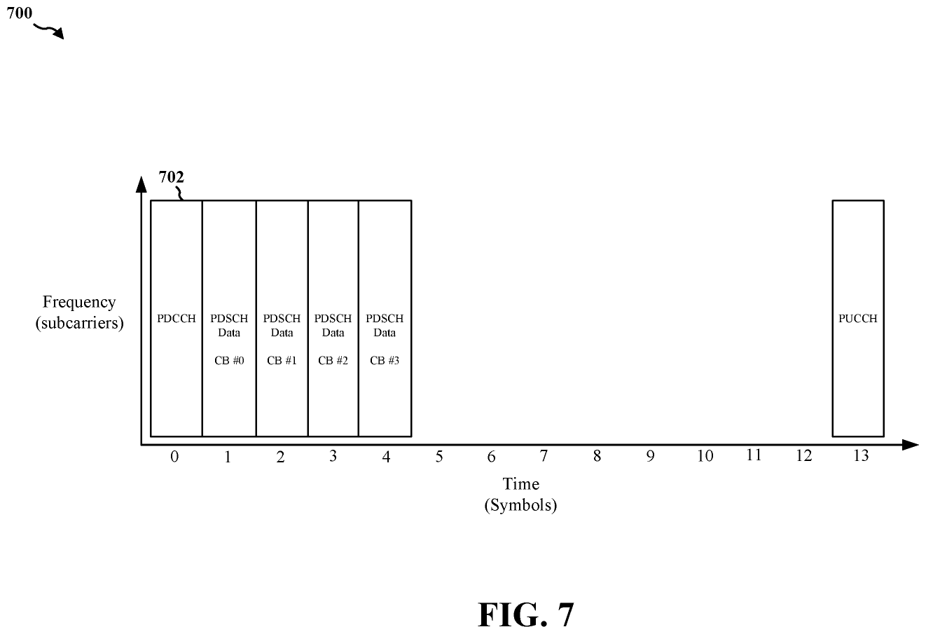

FIG. 7 is a diagram 700 that illustrates an example URLLC subframe for decreasing latency according to certain aspects of the disclosure. As noted, data aided receivers for an URLLC may be utilized to permit removal of DMRS from symbols of the URLLC subframe. In some configuration, an absence of DMRS may facilitate an even shorter DL reception. For example, a number of code blocks in the DL reception of the diagram 700 is a same number of code blocks as the number of code blocks in the DL reception of the diagram 500. However, the DL reception in the diagram 700 is shorter than the DL reception in the diagram 500 because the diagram 500 also includes two DMRSs 506a-506b over the symbol length of the DL reception. As a result, latency corresponding to the diagram 700 may be decreased from the latency corresponding to the diagram 500, even though a same number of code blocks is demodulated and decoded in both diagrams 500 and 700.

Unlike the diagram 500 where decoding and processing of the first code block does not begin until symbol 6 (e.g., after the second DMRS 506b is received), the lack of DMRS symbols in the diagram 700 may provide a further advantage of being able to start processing each of the code blocks as soon as each code block is received by the UE, which thereby decrease the latency. Similar to the diagram 600, each code block in the diagram 700 may be re-encoded and re-modulated and used as a phase reference for the next symbol. The process of re-encoding and re-modulating each code block to provide a reference code block for estimating the channel for the next symbol may be similar to the process described above with respect to the diagram 600.

Channel estimations may be updated at each symbol after receipt of each previous code block. For multi-DMRS subframes, the latency and the overall performance of the UE may be increased by the re-encoding scheme. For single DMRS subframes, the overall performance of the UE may be improved by the re-encoding scheme, as single DMRS configurations are not generally based on techniques for tracking time variations in the channel. That is, to track a time variation of the channel, interpolation may be performed between two DMRSs or extrapolation may be performed outside the two DMRSs.

Following demodulation, decoding, and/or equalization of a code block, re-encoding may be performed based on a mapping of channel bits to a constellation. Data may be decoded and mapped to the constellation such that a comparison between the mapping and a known signal may be indicative of the channel, which may be further used to demodulate and decode a next code block. In some configurations, error correcting techniques may also be executed for decoding processes such as, for example, when the channel is mapped to a different quadrant of the constellation than that of the known transmission.

In some aspects, when DMRS is used in the URLLC subframe, the DMRS may occupy an entire symbol. In another aspect, the DMRS may occupy one-half of a symbol or one-third of the symbol (e.g., 2 carriers over every 6 carriers). In a control channel, such as the PDCCH 702, the DMRS may occupy one-fourth of the symbol. Hence, DMRS may be included in the DL reception to aid channel estimation techniques that utilize the re-encoding scheme. For example, a quality of the decoding process may be increased by additional/limited pilots incorporated throughout the DL reception based on an increased likelihood that the data will be successfully decoded. In some configurations, the additional/limited pilots may occupy less than one-third of the symbol, which may also correspond to none of the symbol, as described above.

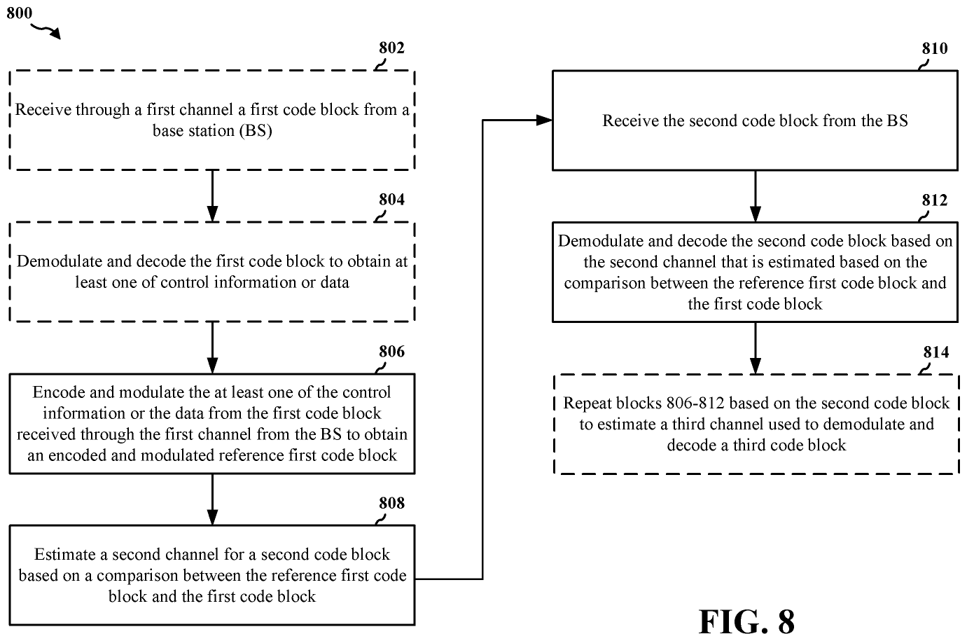

FIG. 8 is a flowchart 800 of a method of wireless communication. The method may be performed by a UE (e.g., the UE 402), which may include the memory 360 and which may be the entire UE 402 or a component of the UE 402, such as the TX processor 368, the RX processor 356, and/or the controller/processor 359).

At 802, the UE 402 may receive, through a first channel, a first code block from a base station. For example, referring to FIG. 4, the UE 402 may receive the first code block at 406 from the base station 404 through the first channel.

At 804, the UE 402 may demodulate and decode the first code block to obtain at least one of control information or data. For example, referring to FIG. 4, the UE 402 may demodulate and decode the first code block at 408 to obtain the control information and/or the data. In aspects, the UE 402 may receive the first code block in a PDCCH received in a first symbol (e.g., the PDCCHs 502, 602, 702 received in the first symbol of the diagrams 500, 600, 700). In other aspects, the first code block may be a PDSCH received in a first symbol, where the first symbol may refer to a symbol of the diagrams 500, 600, 700 that includes a PDSCH.

At 806, the UE 402 encodes and modulates at least one of the control information or the data from the first code block received through the first channel from the base station to obtain an encoded and modulated reference first code block. For example, referring to FIG. 4, the UE 402 may encode and module the control information and/or the data at 410 from the first code block received at 406 from the base station 404 through the first channel to obtain an encoded and modulated reference first code block. In aspects, the control information from the PDCCH (e.g., the PDCCH 602) may be encoded and modulated to obtain the reference first code block. In other aspects, data from the PDSCH (e.g., the PDSCH 604) may be encoded and modulated to obtain the reference first code block.

At 808, the UE 402 may estimate a second channel for a second code block based on a comparison between the reference first code block and the first code block. For example, referring to FIG. 4, the UE 402 may estimate a next channel (e.g., the second channel) at 412 for a second code block based on a comparison between the reference first code block obtained via 410 and the first code block received at 406. In aspects, the second channel may be estimated independently of reference signals (e.g., independently of DMRS) within the PDSCH (e.g., the PDSCH 604). For example, the PDSCH may exclude (e.g., not carry) reference signals. In other aspects, channel estimation (e.g., estimations of the second channel) may be based on reference signals within a PDSCH that, for example, occupy less than ⅓ of a symbol within the PDSCH.

At 810, the UE 402 may receive the second code block from the base station. For example, referring to FIG. 4, the UE 402 receives the second code block at 414 from the base station 404. The second code block may be a PDSCH (e.g. the PDSCH 604) received in a second symbol subsequent to the first symbol.

At 812, the UE 402 demodulates and decodes the second code block based on the second channel that is estimated based on the comparison between the reference first code block and the first code block. For example, referring to FIG. 4, the UE 402 demodulates and decodes the second code block at 416 based on the next estimated channel (e.g., the estimated second channel) that was estimated at 412 based on the comparison between the reference first code block obtained via 410 and the first code block received at 406. The UE 402 may demodulate and decode the second code block immediately after receiving the second code block at 414 from the base station 404.

At 814, the UE 402 may repeat blocks 806-812 based on the second code block to estimate a third channel used to demodulate and decode a third code block. More specifically, the UE 402 may encode and modulate data from the second code block received through the second channel from the base station to obtain an encoded and modulated reference second code block; estimate a third channel for a third code block based on a comparison between the reference second code block and the second code block; receive the third code block from the base station; and demodulate and decode the third code block based on the third channel that is estimated based on the comparison between the reference second code block and the second code block. For example, referring to FIG. 4, the UE 402 may repeat at 418 for the next N code blocks, the process of encoding and modulating data at 410 to obtain an encoded and modulated reference code block for estimating a next channel at 412, so that a next code block received in the next channel may be demodulated and decoded at 416.

The second code block and the third code block may be PDSCHs received in different symbols. The UE 402 may demodulate and decode the third code block further based on the first channel that is estimated based on the comparison between the reference first code block and the first code block. For example, in some configurations, the third code block may be demodulated and decoded based on both the estimated first channel and the estimated second channel using an extrapolation technique.

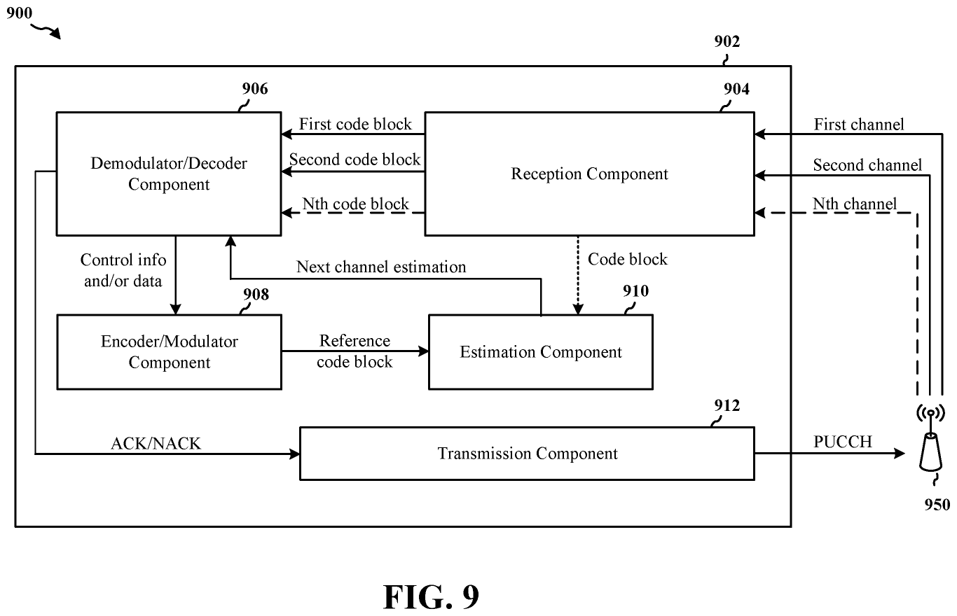

FIG. 9 is a conceptual data flow diagram 900 illustrating the data flow between different means/components in an example apparatus 902. For example, the apparatus 902 may be a UE (e.g., the UE 402). The apparatus 902 includes a reception component 904 that receives one or more code blocks (e.g., a first code block through an Nth code block) from a base station 950 through one or more channels (e.g., a first channel through an Nth channel). As described in connection with 802, the reception component 904 may receive through a first channel a first code block from a base station. The apparatus 902 further includes a demodulator/decoder component 906 that demodulates and decodes the one or more code blocks received by the reception component 904 through the one or more channels. That is, the reception component 904 may provide the one or more code blocks to the demodulator/decoder component 906 to demodulate and decode the one or more code blocks. For example, as described in connection with 804, the demodulator/decoder component 906 may demodulate and decode the first code block to obtain at least one of control information or data associated with the first code block.

The apparatus 902 includes an encoder/modulator component 908 that receives the control information and/or the data obtained by the demodulator/decoder component 906. The encoder/modulator component 908 re-encodes and re-modulates the control information and/or the data to obtain a reference code block that corresponds to the code block included in the one or more code blocks demodulated and decoded by the demodulator/decoder component 906. For example, as described in connection with 806, the encoder/modulator component 908 may encode and modulate the at least one of the control information or data from the first code block received through the first channel from the base station 950 to obtain an encoded and modulated reference first code block.

The apparatus 902 includes an estimation component 910 that estimates a next channel for a next code block based on a comparison between the reference code block and the code block. For example, as described in connection with 808, the estimation component 910 may estimate a second channel for a second code block based on a comparison between the reference first code block and the first code block. The estimation component 910 may receive the code block, or information associated with the code block, from the reception component 904 to perform the comparison between the code block and the reference code block that is received from the encoder/modulator component 908. The channel estimation for the next channel is provided from the estimation component 910 to the demodulator/decoder component 906.

The reception component 904 may receive the next code block from the base station 950 through a next channel and provide the next code block to the demodulator/decoder component 906. For example, as described in connection with 810, the reception component 904 may receive the second code block from the base station. The demodulator/decoder component 906 is configured to demodulate and decode the next code block included in the one or more code blocks provided from the reception component 904 based on the next channel estimation received from the estimation component 910. For example, as described in connection with 812, the demodulator/decoder component 906 may demodulate and decode the second code block based on the second channel that is estimated based on the comparison between the reference first code block and the first code block.

The process of re-encoding and re-modulating data to obtain an encoded and modulated reference code block for estimating a next channel, so that a next code block received in the next channel may be demodulated and decoded, may continue up to an Nth code blocks received from the base station 950 through an Nth channel. After the one or more code blocks are demodulated and decoded, the demodulator/decoder component 906 may provide ACK/NACK feedback to a transmission component 912 indicative of whether the one or more code blocks were successfully decoded by the demodulator/decoder component 906. The transmission component 912 transmits the ACK/NACK feedback to the base station 950 in a PUCCH.

The apparatus 902 may include additional components that perform each of the blocks of the algorithm in the aforementioned flowchart of FIG. 8. As such, each block in the aforementioned flowchart of FIG. 8 may be performed by a component and the apparatus 902 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

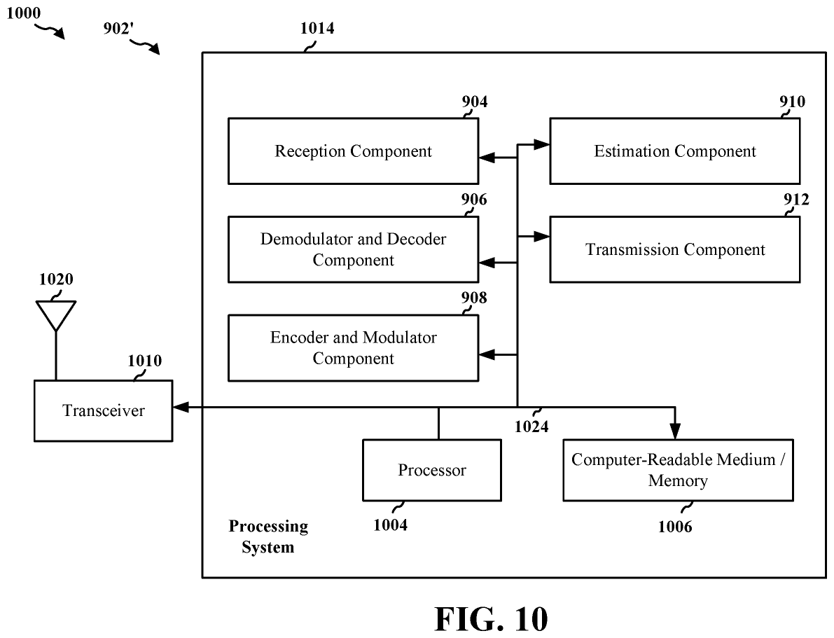

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904-912, and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 912, and based on the received information, generates a signal to be applied to the one or more antennas 1020.

The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software.

The processing system 1014 further includes at least one of the components 904-912. The components may be software components running in the processor 1004, resident/stored in the computer readable medium/memory 1006, one or more hardware components coupled to the processor 1004, or some combination thereof. The processing system 1014 may be a component of the UE 350 and may include the memory 360 and/or at least one of the TX processor 368, the RX processor 356, and the controller/processor 359. Alternatively, the processing system 1014 may be the entire UE (e.g., see 350 of FIG. 3).

In one configuration, the apparatus 902/902′ for wireless communication includes means for receiving, demodulating and decoding, encoding and modulating, estimating, and transmitting. The aforementioned means may be one or more of the aforementioned components of the apparatus 902 and/or the processing system 1014 of the apparatus 902′ configured to perform the functions recited by the aforementioned means. As described supra, the processing system 1014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Accordingly, data aided receivers may be utilized for decoding the code blocks independent of DMRS. An absence of DMRS from an URLLC subframe may be based on re-encoding and re-modulating control information and/or data obtained from a first code block received through a first channel to further obtain a reference first code block. The reference first code block may be compared to the first code block to estimate a second channel for a second code block. The second code block may be decoded based on the estimated second channel. A cycle of using a reference code block as a phase reference for the next symbol may be continued for N code blocks in the DL reception. In this manner, since no symbols need to be allocated for receiving DMRS, not only may decoding of the first code block begin immediately after the first code block is received, but additional code blocks may be received in symbols that may otherwise have been reserved for receiving the DMRS, thereby increasing the coding rate/throughput of the data. Additionally or alternatively, since no symbols need to be allocated for receiving the DMRS, the DL reception time may be shortened by the time needed for symbols that may otherwise have been reserved for receiving the DMRS, which may decrease latency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is for wireless communication of a wireless device at a user equipment (UE), characterized by: encoding and modulating at least one of control information or data from a first code block received through a first channel from a base station (BS) to obtain an encoded and modulated reference first code block; estimating a second channel for a second code block based on a comparison between the reference first code block and the first code block; receiving the second code block from the BS; and demodulating and decoding the second code block based on the second channel that is estimated based on the comparison between the reference first code block and the first code block.

Example 2 may be combined with Example 1 and is further characterized by receiving through the first channel the first code block from the BS; and demodulating and decoding the first code block to obtain the at least one of the control information or the data.

Example 3 may be combined with any of Examples 1 to 2 and is characterized in that the first code block is a physical downlink control channel (PDCCH) received in a first symbol, and characterized in that control information from the PDCCH is encoded and modulated to obtain the reference first code block.

Example 4 may be combined with Example 3 and is characterized in that the second code block is a physical downlink shared channel (PDSCH) received in a second symbol subsequent to the first symbol.

Example 5 may be combined with any of Examples 1 to 2 and is characterized in that the first code block is a physical downlink shared channel (PDSCH) received in a first symbol, and characterized in that data from the PDSCH is encoded and modulated to obtain the reference first code block.

Example 6 may be combined with Example 5 and is characterized in that the second code block is a PDSCH received in a second symbol subsequent to the first symbol.

Example 7 may be combined with any of Examples 1 to 6 and is characterized in that the second channel is estimated independently of reference signals (RS) within a physical downlink shared channel (PDSCH).

Example 8 may be combined with Example 7 and is characterized in that the PDSCH excludes RS.

Example 9 may be combined with any of Examples 1 to 8 and is characterized in that the second code block is demodulated and decoded immediately after receiving the second code block from the BS.

Example 10 may be combined with any of Examples 1 to 6 and 9 and is characterized in that estimation of the second channel is further based on reference signals (RS) within a physical downlink shared channel (PDSCH), the RS occupying less than ⅓ of a symbol within the PDSCH.

Example 11 may be combined with any of Examples 1 to 10 and is further characterized by: encoding and modulating data from the second code block received through the second channel from the BS to obtain an encoded and modulated reference second code block; estimating a third channel for a third code block based on a comparison between the reference second code block and the second code block; receiving the third code block from the BS; and demodulating and decoding the third code block based on the third channel that is estimated based on the comparison between the reference second code block and the second code block.

Example 12 may be combined with Example 11 and is characterized in that the third code block is demodulated and decoded further based on the first channel that is estimated based on the comparison between the reference first code block and the first code block.

Example 13 may be combined with any of Examples 11 to 12 and is characterized in that the second code block and the third code block are physical downlink shared channel (PDSCHs) received in different symbols.

What is claimed is:

1. A method of wireless communication of a wireless device at a user equipment (UE), comprising:
encoding and modulating at least one of control information or data from a first code block received through a first channel from a base station (BS) to obtain an encoded and modulated reference first code block;
estimating a second channel for a second code block based on a comparison between the reference first code block and the first code block;
receiving the second code block from the BS; and
demodulating and decoding the second code block based on the second channel that is estimated based on the comparison between the reference first code block and the first code block.

2. The method of claim 1, further comprising:
receiving through the first channel the first code block from the BS; and
demodulating and decoding the first code block to obtain the at least one of the control information or the data.

3. The method of claim 1, wherein the first code block is a physical downlink control channel (PDCCH) received in a first symbol, and wherein control information from the PDCCH is encoded and modulated to obtain the reference first code block.

4. The method of claim 3, wherein the second code block is a physical downlink shared channel (PDSCH) received in a second symbol subsequent to the first symbol.

5. The method of claim 1, wherein the first code block is a physical downlink shared channel (PDSCH) received in a first symbol, and wherein data from the PDSCH is encoded and modulated to obtain the reference first code block.

6. The method of claim 5, wherein the second code block is a PDSCH received in a second symbol subsequent to the first symbol.

7. The method of claim 1, wherein the second channel is estimated independently of reference signals (RS) within a physical downlink shared channel (PDSCH).

8. The method of claim 7, wherein the PDSCH excludes RS.

9. The method of claim 1, wherein the second code block is demodulated and decoded immediately after receiving the second code block from the BS.

10. The method of claim 1, wherein estimation of the second channel is further based on reference signals (RS) within a physical downlink shared channel (PDSCH), the RS occupying less than ⅓ of a symbol within the PDSCH.

11. The method of claim 1, further comprising:
encoding and modulating data from the second code block received through the second channel from the BS to obtain an encoded and modulated reference second code block;
estimating a third channel for a third code block based on a comparison between the reference second code block and the second code block;
receiving the third code block from the BS; and
demodulating and decoding the third code block based on the third channel that is estimated based on the comparison between the reference second code block and the second code block.

12. The method of claim 11, wherein the third code block is demodulated and decoded further based on the first channel that is estimated based on the comparison between the reference first code block and the first code block.

13. The method of claim 11, wherein the second code block and the third code block are physical downlink shared channel (PDSCHs) received in different symbols.

14. An apparatus for wireless communication, the apparatus being a wireless device at a user equipment (UE), comprising:
a memory; and
at least one processor coupled to the memory and configured to:
encode and modulating at least one of control information or data from a first code block received through a first channel from a base station (BS) to obtain an encoded and modulated reference first code block;
estimate a second channel for a second code block based on a comparison between the reference first code block and the first code block;
receive the second code block from the BS; and
demodulate and decoding the second code block based on the second channel that is estimated based on the comparison between the reference first code block and the first code block.

15. The apparatus of claim 14, wherein the at least one processor is further configured to:
receive through the first channel the first code block from the BS; and
demodulate and decoding the first code block to obtain the at least one of the control information or the data.

16. The apparatus of claim 14, wherein the first code block is a physical downlink control channel (PDCCH) received in a first symbol, and wherein control information from the PDCCH is encoded and modulated to obtain the reference first code block.

17. The apparatus of claim 16, wherein the second code block is a physical downlink shared channel (PDSCH) received in a second symbol subsequent to the first symbol.

18. The apparatus of claim 14, wherein the first code block is a physical downlink shared channel (PDSCH) received in a first symbol, and wherein data from the PDSCH is encoded and modulated to obtain the reference first code block.

19. The apparatus of claim 18, wherein the second code block is a PDSCH received in a second symbol subsequent to the first symbol.

20. The apparatus of claim 14, wherein the second channel is estimated independently of reference signals (RS) within a physical downlink shared channel (PDSCH).

21. The apparatus of claim 20, wherein the PDSCH excludes RS.

22. The apparatus of claim 14, wherein the second code block is demodulated and decoded immediately after receiving the second code block from the BS.

23. The apparatus of claim 14, wherein estimation of the second channel is further based on reference signals (RS) within a physical downlink shared channel (PDSCH), the RS occupying less than ⅓ of a symbol within the PDSCH.

24. The apparatus of claim 14, wherein the at least one processor is further configured to:
encode and modulating data from the second code block received through the second channel from the BS to obtain an encoded and modulated reference second code block;
estimate a third channel for a third code block based on a comparison between the reference second code block and the second code block;
receive the third code block from the BS; and
demodulate and decoding the third code block based on the third channel that is estimated based on the comparison between the reference second code block and the second code block.

25. The apparatus of claim 24, wherein the third code block is demodulated and decoded further based on the first channel that is estimated based on the comparison between the reference first code block and the first code block.

26. The apparatus of claim 24, wherein the second code block and the third code block are physical downlink shared channel (PDSCHs) received in different symbols.

27. An apparatus for wireless communication, the apparatus being a wireless device at a user equipment (UE), comprising:
means for encoding and modulating at least one of control information or data from a first code block received through a first channel from a base station (BS) to obtain an encoded and modulated reference first code block;
means for estimating a second channel for a second code block based on a comparison between the reference first code block and the first code block;
means for receiving the second code block from the BS; and
means for demodulating and decoding the second code block based on the second channel that is estimated based on the comparison between the reference first code block and the first code block.

28. A computer-readable medium storing computer executable code, the code when executed by at least one processor of a wireless device at a user equipment (UE), causes the at least one processor to:
encode and modulating at least one of control information or data from a first code block received through a first channel from a base station (BS) to obtain an encoded and modulated reference first code block;
estimate a second channel for a second code block based on a comparison between the reference first code block and the first code block;
receive the second code block from the BS; and
demodulate and decoding the second code block based on the second channel that is estimated based on the comparison between the reference first code block and the first code block.
